(19) United States
(12) Patent Application Publication
(10) Pub. No.: US 2022/0378059 A1
(43) Pub. Date: Dec. 1, 2022

(54) BEVERAGE INGREDIENT TREATMENT METHOD AND RELATED PACKAGED INGREDIENT

(71) Applicant: Koninklijke Douwe Egberts B.V., Utrecht (NL)

(72) Inventor: Fabian Guilmineau, Banbury (GB)

(21) Appl. No.: 17/776,520

(22) PCT Filed: Nov. 12, 2020
(86) PCT No.: PCT/EP2020/081948

§ 371 Date: May 12, 2022

(30) Foreign Application Priority Data
Nov. 15, 2019 (GB) 1916643.8

(51) Int. Cl. A23F 5/04; A23F 5/10

(52) U.S. Cl. CPC A23F 5/04; A23F 5/105

(57) ABSTRACT

The invention provides a method of treating a roasted beverage ingredient, the method comprising the step of incubating the ingredient at between −10° C. and 8° C. for 30 to 300 minutes. The roasted beverage ingredient may subsequently be packaged and be stored at a temperature between 2° C. and ambient for at least one week before opening the package.

### TECHNICAL FIELD OF THE INVENTION

The present invention relates to a method of treating a roasted beverage ingredient and a packaged beverage ingredient obtained by said method. The invention further relates to a packaged beverage ingredient.

### BACKGROUND TO THE INVENTION

The increasing interest and demand for high-quality whole roast and ground beans for the preparation of coffee beverages at home and/or in public places, such as for example coffee shops, hotels and restaurants, has brought the coffee industry to focus on new methods to ensure freshness of its products. Preserving the freshness of the roasted coffee beans during their shelf-life remains a key factor in delivering a high in-cup quality beverage.

It is well known to the skilled person in the art that exposure to oxygen and humidity during the time between roasting and packaging is detrimental to the quality of roasted coffee beans. Particularly the level of oxygen present during packing and after packaging needs to be adjusted to reduce the risk of aging or staling the freshly roasted coffee beans.

Experts have developed a Freshness Index (FI) to determine the level of freshness of roasted coffee beans during their shelf-life. Said Freshness Index (FI) has been defined in several ways but in essence it reflects changes happening in the aroma profile (VOCs amounts and distributions) of roasted coffee beans over time. Methanethiol has been found to be particularly suitable for measuring freshness of roasted coffee beans. This volatile organic compound is present in high concentrations in freshly roasted whole coffee beans and deteriorates rapidly over time in the presence of oxygen and temperature, which can have a major impact on its degradation. For this reason researchers have often used methanethiol as key compound to determine the Freshness Index (FI) of roasted coffee beans.

Particularly for the purpose of this invention the ratio between 2-butanone and methanethiol, as reported in the equation below:

Freshness Index (FI)=[2−butanone]/[Methanethiol]

has been found to better express the freshness of roasted whole coffee beans; the lower the Freshness Index (FI) the fresher the roasted coffee beans. Although as mentioned above it is well known that temperature plays a key role in the shelf-life of roasted coffee beans and their aroma profile during storage, little information is available on the effect of temperature on the roasted coffee beans during the time between the roasting and the packaging processes and how this influences the evolution of beans' freshness during shelf-life.

It would be therefore advantageous to provide a solution would provide roasted coffee beans with a low Freshness Index at first opening without the necessity to store the roasted whole coffee beans at low temperature during their shelf-life.

Finally, it would be furthermore advantageous to provide a solution which would provide roasted coffee beans with a low Freshness Index for several days after first opening (pantry life), without requiring storage at low temperature after first opening.

It is therefore an aim of embodiments of the invention to overcome or mitigate at least one problem of the prior art whether disclosed herein or not.

### SUMMARY OF THE INVENTION

According to a first aspect of the invention there is provided a method of treating a roasted beverage ingredient, the method comprising the step of:

a) incubating the ingredient at between −10° C. and 8° C. for 30 to 300 minutes.

In some embodiments step a) may last between 30 to 240 minutes. In some embodiments step a) may last at least 40, 50, 60, 70, 80, 90, 100, 110 or at least 120 minutes. In some embodiments step a) may last no more than 210, 200, 190, 180, 170, 160 or no more than 150 minutes.

In some embodiments the incubating step a) may comprise contacting the ingredient with a cooling agent. Cooling agents may include gases, liquids or solids (such as liquid nitrogen, or solid CO₂, for example). Step a) may comprise flushing the ingredient with one or more cooling agents, such as a cooled fluid (which may be a gas, liquid or solid after cooling).

In some embodiments said cooled fluid may have a temperature less than 8° C. In some embodiments said temperature may be less than 5° C., 2° C., 0° C., −5° C., −10° C., −30° C., −50° C., −70° C., −100° C., −130° C., or less than −200° C.

In some embodiments said one or more cooled fluid may comprise nitrogen, carbon dioxide and/or air.

In some embodiments the incubating step a) may be performed in a refrigerated vessel.

In some embodiments the incubating step a) may comprise a first temperature reducing step and then a temperature maintenance step. The temperature reducing step may comprise flushing with a cooled fluid, as described above and the temperature maintenance step may comprise refrigeration of the cooled ingredient at between −10° C. and 8° C. In some embodiments the temperature maintenance step comprises at least 30 minutes, at least 40 minutes, at least 50 minutes or at least 60 minutes.

In some embodiments said refrigerated vessel may comprise a refrigerator, a continuous cooling tunnel, a refrigerated conveying screw (e.g. cryo-screw), a cooling silo, a blast chiller, an agitated cooling vessel or a fluidised bed chiller.

In some embodiments the method may further comprise, before step a), the step of:

b) reducing the amount of oxygen surrounding the ingredient down to less than 5%.

In some embodiments step b) may comprise a cooled fluid flushing of the beverage ingredient.

In some embodiments said cooled fluid may comprise nitrogen, carbon dioxide flushing and/or a combination thereof.

In some embodiments said cooled fluid may be a liquid, a gas or a combination thereof.

In some embodiments the method may further comprise, during or after step a), the step of:

c) packing the ingredient.

In some embodiments step a) and c) may be started, performed and/or ended simultaneously.

In some embodiments, the packing step c) may last between 1 to 60 minutes.

In some embodiments step a) may last less than 300 minutes and packing step c) less than 60 minutes.

In some embodiments step a) may last at least 30 minutes and packing step c) less than 60 minutes.

In some embodiments step c) may start less than 10 to 30 minutes after step a) finishes.

In some embodiment step a) and c) may end simultaneously.

In some embodiments the packing step c) may be performed during step a) and may last 1 second to 60 minutes.

In some embodiments, the method may comprise after step c) the step of:

d) storing the ingredient at a temperature in the range of between 2° C. to ambient temperature, such as between 2° C. and 35° C., preferably between 2° C. and 30° C., for at least 1 week before first opening.

In some embodiments step d) may last at least 2, 3 or 4 weeks, such as between 2 to 52 weeks before first opening of the packaged ingredient, preferably 2 to 26 weeks.

In some embodiments step d) may be carried out at a temperature between 8 to 25° C. In some embodiments step d) may be carried out at a temperature of at least 8° C., 9° C. or at least 10° C. and/or no more than 25° C., 24° C., 23° C., 22° C., 21° C. or 20° C.

According to a second aspect of the invention there is provided a packaged beverage ingredient obtained or obtainable by the method of the first aspect of the invention wherein the packaged ingredient may be characterised by a 2-butanone to methanethiol concentration ratio of no more than 20:1 in the packaged ingredient on the day of first opening of the packaged ingredient, and a 2-butanone to methanethiol concentration ratio of no more than 110:1 seven days after first opening.

In some embodiments of the first or second aspect of the invention, the roasted beverage ingredient or packaged beverage ingredient may comprise roasted coffee, preferably roasted whole coffee beans.

In some embodiments, the roasted whole coffee beans may comprise pure Arabica whole coffee beans.

In some embodiments, the roasted whole coffee beans may comprise pure Robusta whole coffee beans.

In some embodiments, the roasted whole coffee beans may comprise a Robusta and Arabica whole coffee beans blend, particularly with an Arabica to Robusta whole coffee beans blend ratio in the range of around 50%:50% to around 90%:10%, preferably around 70%:30%.

In some embodiments, when the roasted whole coffee beans comprise a Robusta and Arabica whole coffee beans blend the packaged ingredient may be characterised by a 2-butanone to methanethiol concentration ratio of no more than 10:1 in the packaged ingredient on the day of first opening of the packaged ingredient, and a 2-butanone to methanethiol concentration ratio of no more than 60:1 seven days after first opening.

In some embodiments, when the roasted whole coffee beans comprise pure Arabica whole coffee beans the packaged ingredient may be characterised by a 2-butanone to methanethiol concentration ratio of no more than 10:1 in the packaged ingredient on the day of first opening of the packaged ingredient, and a 2-butanone to methanethiol concentration ratio of no more than 105:1 seven days after first opening.

In some embodiments, when the roasted whole coffee beans comprise pure Robusta whole coffee beans the packaged ingredient may be characterised by a 2-butanone to methanethiol concentration ratio of no more than 20:1 in the packaged ingredient on the day of first opening of the packaged ingredient, and a 2-butanone to methanethiol concentration ratio of no more than 80:1 seven days after first opening.

In some embodiments the beverage ingredient is stored for at least 1 week after packing and before first opening.

In some embodiments the beverage ingredient has been stored for 2 to 52 weeks after packing and before first opening, preferably between 4 to 26 weeks.

According to a third aspect of the invention there is provided packaged roast coffee, wherein the coffee is characterised by a 2-butanone to methanethiol concentration ratio of no more than 20:1 in the packaged coffee on the day of first opening of the packaged coffee, and a 2-butanone to methanethiol concentration ratio of no more than 110:1 seven days after first opening.

The roast coffee may be whole roast coffee beans, and may be as described in relation to the second aspect of the invention.

### DETAILED DESCRIPTION OF THE INVENTION

In order that the invention may be more clearly understood, embodiments thereof will now be described, by way of example only, with reference to the accompanying drawings of which:

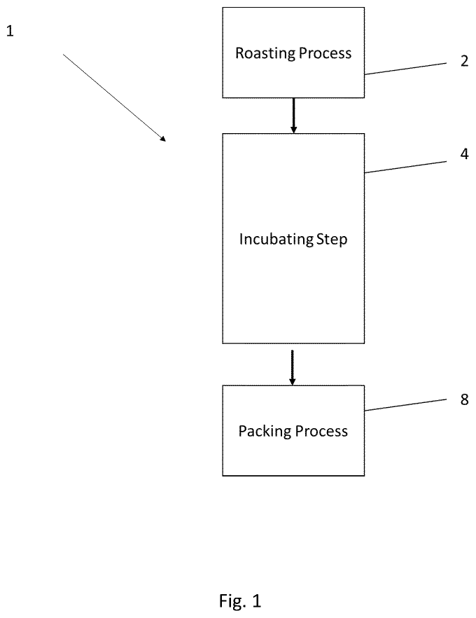

FIG. 1 illustrates a schematic flow diagram of a first embodiment of a method according to the first aspect of the invention;

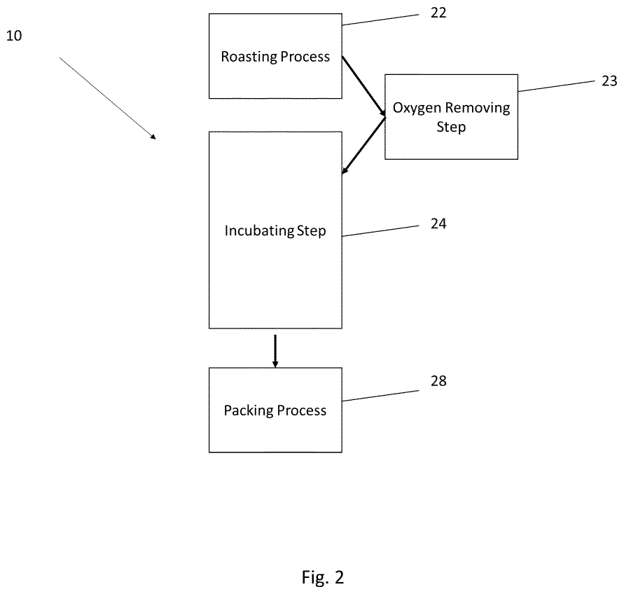

FIG. 2 illustrates a schematic flow diagram of a second embodiment of a method according to the first aspect of the invention;

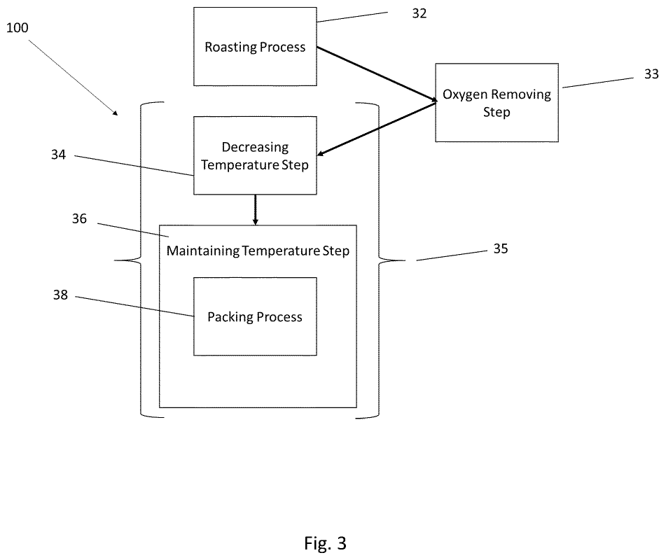

FIG. 3 illustrates a schematic flow diagram of a third embodiment of a method according to the first aspect of the invention;

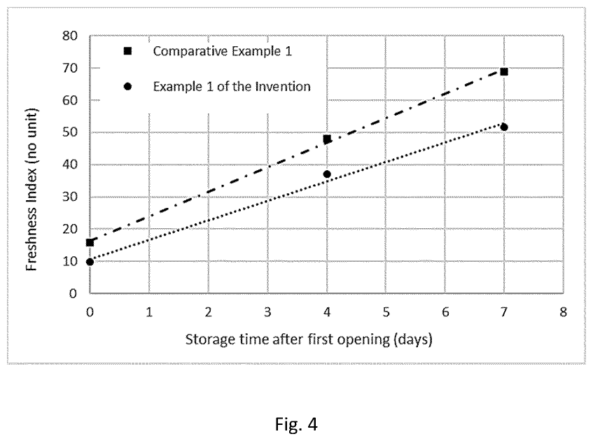

FIG. 4 illustrates a graph of a Freshness Index (FI) over time for a first embodiment of a beverage ingredient of the second and third aspect of the invention in comparison to a beverage ingredient obtained through a method of the prior art.

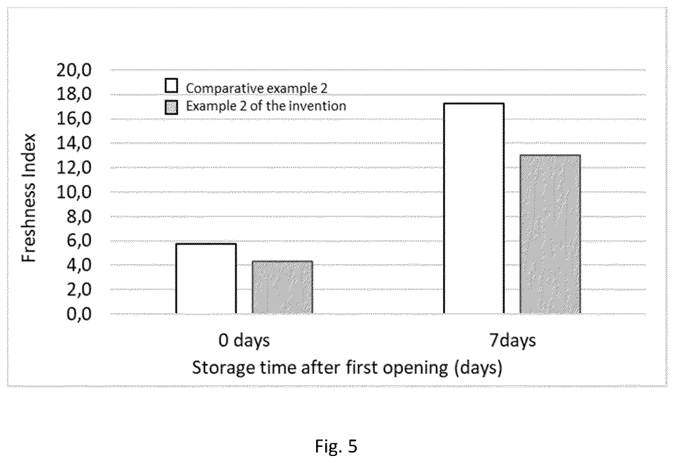

FIG. 5 illustrates a graph of a Freshness Index (FI) over time for a second embodiment of a beverage ingredient of the second and third aspect of the invention in comparison to a beverage ingredient obtained through a method of the prior art.

Referring to the Figures, like numbers represent like components.

Referring firstly to FIG. 1, a schematic flow diagram (1) of a first embodiment of a method of the first aspect of the invention is shown.

A roasting process (2) is performed on whole green coffee beans followed by an incubating step (4) in which the temperature of the resulting roasted whole coffee beans is decreased and maintained at a desired temperature. The cooled roasted whole coffee beans are then sent to a packing process (8) to be packed and stored for subsequent transport, sale and/or use.

The roasting process (2) can be carried out through conventional roasting processes, for example through a hot air roasting process and/or roasting processes using alternative gases such as for example steam water, nitrogen and/or carbon dioxide (CO₂) and/or a combination thereof in conventional appliances, for instance drum roasters, fluidised bed roasters, bowl roasters, rotating bowl roasters, tangential roasters, operated either in continuous or batch processing, selecting the preferred temperature-time roasting profile suitable for the specific blend of the green coffee beans used.

The roasted whole coffee beans are then subjected to the incubating step (4) in which the beans' temperature is lowered to between −10° C. and 8° C. The incubating step (4) is carried out by means of first flushing the roasted whole coffee beans with a flow of cold air and/or any suitable alternative gas and/or gas mixture (for instance CO₂ and/or nitrogen) at a temperature of −50° C. to −15° C. or alternatively/additionally by spraying the roasted whole coffee beans with liquid nitrogen at a temperature between −210° C. and −196° C., or contacting the beans with dry ice (i.e. frozen carbon dioxide CO₂) at or below −79° C. The final temperature reached by the roasted whole coffee beans (in the range of −10° C. to 8° C.) is then maintained as such by means of conventional refrigerators during the incubating step (4) for a period of time in the range of 30 to 300 minutes, particularly 60 to 240 minutes.

The roasted whole coffee beans are then sent by means of conventional transport/transfer systems (for example pneumatic or mechanical conveying systems such as conveyor belts and infinite screws) to the packing process (8) to be packed through a standard packing process such as for example vacuum packing process or modified atmosphere ambient pressure packing process for the production of vacuum-packed coffee bricks, coffee pouches, bags and/or tins.

Referring now to FIG. 2 a schematic flow diagram (10) of a second embodiment of a method of the first aspect of the invention is shown.

A roasting process (22) is performed on whole green coffee beans, after which the roasted whole coffee beans are treated to decrease the oxygen level surrounding the beans through a conventional oxygen reduction step (23). The temperature of the roasted whole beans is lowered and then maintained at the set temperature during an incubating step (24). The cooled roasted whole coffee beans are then sent to a packing process (28) to be packed and stored for subsequent transport, sale and/or use. The temperature lowering step and/or temperature maintenance step may comprise the oxygen removing step.

The roasting process (22) is carried out through conventional roasting processes and appliances as described above in relation to FIG. 1.

The roasted whole coffee beans obtained from the roasting process (22) are then treated to at least partially remove the oxygen surrounding the beans in order to reach a level of oxygen at least below 5%, preferably below 2% by volume. The oxygen reduction step (23) is carried out by means of conventional oxygen removal processes, for example flushing the roasted whole coffee beans with liquid and/or gaseous nitrogen while stirring the beans in conventional vessels. Any alternative suitable food-grade gas or gas mixtures can be used which reduces the amount of oxygen surrounding the roasted whole coffee beans to obtain an environment with a modified atmosphere where the presence of residual oxygen is diluted to a level of below 2%. Alternative gasses can be selected from the group of carbon dioxide (CO₂) and/or argon and/or helium.

After having at least partially removed the amount of oxygen surrounding the roasted whole coffee beans, the roasted coffee beans are treated at the incubating step (24) to reduce their temperature and maintain it at between −10° C. to 8° C. for a period of time between 30 to 300 minutes, particularly 60 to 240 minutes through modified atmosphere refrigeration devices such as nitrogen flushed refrigerators, in a process as described in relation to FIG. 1 hereinabove. Any alternative conventional refrigerator device can also be used.

In some embodiments the oxygen reduction step (23) is carried out simultaneously to the incubating step (24), with the amount of oxygen surrounding the roasted whole coffee beans being removed by means of flushing and/or spraying and/or contacting the roasted whole coffee beans with liquid nitrogen or any suitable alternative gas, liquid or solid (for instance carbon dioxide CO₂) which does not include presence of oxygen O₂, to lower the beans' temperature. The whole roasted coffee beans are then maintained at between −10° C. to 8° C. for a period of time between 30 to 300 minutes, particularly 60 to 240 minutes as described in relation to FIG. 2 hereinabove.

The roasted whole coffee beans are then sent to the packing process (28) for the production of roasted whole coffee beans packages, as described for the process shown in FIG. 1 hereinabove.

Referring now to FIG. 3, a schematic flow diagram (100) of a third embodiment of a method of the first aspect of the invention is shown.

A roasting process (32) is performed on whole green coffee beans, after which the roasted whole coffee beans are sent to an oxygen reduction step (33) where the amount of oxygen surrounding the beans is reduced to a concentration by volume at least below 5% preferably below 2%. The roasted whole coffee beans are then sent to an incubating step (35) where the roasted whole coffee beans are firstly cooled in a temperature decreasing step (34) and then maintained at the desired temperature in a temperature maintaining step (36), while a packing process (38) of the roasted whole coffee beans is performed to obtain packed roasted whole coffee beans. The resulting packed roasted whole coffee beans are then sent for storage before their transport, sale and/or use.

The roasting process (32), the oxygen reducing step (33) of FIG. 3 are performed as described in relation to the process of FIG. 2, hereinabove.

The incubating step (35) consists of two separate steps: the temperature decreasing (34) and the temperature maintaining (36) steps. Once the roasted whole coffee beans temperature is lowered to a value in the range of −10° C. to 8° C. in the temperature decreasing step (34), the temperature is maintained at that value during the temperature maintaining step (36) for a period of time in the range of between 30 to 300 minutes, particularly 60 to 240 minutes. During this period of time while temperature is maintained lowered the packaging process step (38) is performed and complete in order to ensure that the roasted whole coffee beans are packed in cold conditions and maintained cooled after packed for the period of time required to complete the temperature maintaining step (36).

The roasted whole coffee beans packages are then sent to storage ready to be transported, sold and/or used.

### Comparative Example 1 (Prior Art)

45 kg of a blend of green coffee beans (50% Coffea arabica and 50% Coffea robusta) were roasted using a hot air gas-fired Rotating Fluidised Bed roaster (RFB Duo from Neuhaus-Neotec). The target moisture of the roasted coffee beans was set at 3%, roasting time set at 450 seconds. The resulting roasting degree was measured through a colorimeter model Probat Colorette 3b. The achieved colour measured immediately after roasting was 106 Colour Unit (corresponding to a medium degree of roast, also known as “city” roast).

After roasting, the resulting roasted whole coffee beans were kept in a plastic vessel for 60 minutes (1 hour) at a temperature in the range of 20 to 25° C. in contact with air and then transferred to a packing process to be then manually packed into a multi-layered aluminium flexible pack to produce a sample of a roasted whole coffee beans pouch. The pouch was provided with a one-way valve to release over-pressure due to the development of gases from the roasted whole coffee beans during storage (8 weeks).

### Example 1 of the Invention

5 kg of a blend of green coffee beans (50% Coffea arabica and 50% Coffea robusta) were roasted using a hot air gas-fired Rotating Fluidised Bed roaster (RFB Duo from Neuhaus-Neotec). The target moisture of the roasted coffee beans was set at 3%, roasting time set at 450 seconds. The resulting roasting degree was measured through a colorimeter model Probat Colorette 3b. The achieved colour measured immediately after roasting was 106 Colour Unit (corresponding to a medium degree of roast, also known as “city” roast).

After roasting, the resulting roasted whole coffee beans were transferred to an insulated plastic vessel for incubation, comprising quickly cooling to a final temperature of 4° C., by means of pouring liquid nitrogen over the roasted whole coffee beans, followed by refrigeration at the set cooling temperature of 4° C. for a total of 60 minutes (1 hours), including the cooling step. The beans during incubation were in contact with air. The cold roasted whole coffee beans were then manually packed into a multi-layered aluminium flexible pack to produce a sample of a roasted whole coffee beans pouch. The pouch was provided with a one-way valve to release over-pressure due to the development of gases from the roasted whole coffee beans during storage (8 weeks).

Referring to FIG. 4, for the two samples obtained from Comparative Example 1 and Example 1 of the invention, a Freshness Index (FI) was measured over time as ratio of the two volatile organic compounds 2-butanone and methanethiol, as calculated from the equation below:

Freshness Index (FI)=[2−butanone]/[Methanethiol]

A lower Freshness Index corresponds to fresher roasted whole coffee beans.

For both samples a Freshness Index (FI) was recorded over time (days). The first point was recorded at first opening (0 days), the second point at 4 days from the first opening and the third point at 7 days from the first opening.

Example 1 of the invention shows for all of the three points along the time axis, a Freshness Index (FI) significantly lower in value than the Freshness Index of the Comparative Example 1 of the prior art, indicating that the method of the invention preserves the roasted whole coffee beans from aging better than the conventional methods available in the prior art.

### Comparative Example 2 (Prior Art)

5 kg of a blend of green coffee beans (85% Coffea arabica and 15% Coffea robusta) were roasted using a hot air gas-fired Rotating Fluidised Bed roaster (RFB Junior from Neuhaus-Neotec). The target moisture of the roasted coffee beans was set at 3%, roasting time set at 420 seconds. The resulting roasting degree was measured through a colorimeter model Probat Colorette 3b. The achieved colour measured immediately after roasting was 90 Colour Unit (corresponding to a medium/dark degree of roast, also known as “full city” roast).

After roasting, the resulting roasted whole coffee beans were kept in a plastic vessel for 240 minutes (4 hours) at a temperature in the range of 25 to 30° C. in contact with air and then transferred to a packing process to be then manually packed into a multi-layered aluminium flexible pack to produce a sample of a roasted whole coffee beans pouch. The pouch was provided with a one-way valve to release over-pressure due to the development of gases from the roasted whole coffee beans during storage (8 weeks).

### Example 2 of the Invention

5 kg of a blend of green coffee beans (85% Coffea arabica and 15% Coffea robusta) were roasted as described in the Comparative Example 2 of the prior art, together with the target moisture of the roasted coffee beans, the roasting time and the resulting roasting degree which were set as per the same Comparative Example 2.

After roasting, a quick cooling step of about 2 to 5 minutes was performed over the resulting roasted whole coffee beans. A final temperature of 4° C. was reached by means of spraying liquid nitrogen over the beans while mixing them in a closed conveying screw, followed by refrigeration at the same cooling temperature (4° C.) for a total of 240 minutes (4 hours), including the cooling step. The beans during incubation were in contact with air. The cold roasted whole coffee beans were then manually packed into a multi-layered aluminium flexible pack (pouch) under reduced oxygen conditions (O₂ amount less than 2%). A one-way valve was provided to the pouch to release gas over-pressure from the roasted whole coffee beans during storage (2 weeks).

Referring now to FIG. 5, for the two samples obtained from Comparative Example 2 and Example 2 of the invention a Freshness Index (FI) was measured over time as ratio of the two volatile organic compounds 2-butanone and methanethiol, as calculated from the equation below:

Freshness Index (FI)=[2−butanone]/[methanethiol]

Example 2 of the invention shows a Freshness Index (FI) lower in value than the Freshness Index of the Comparative Example 2 of the prior art, at first opening as well as at 7 days from the first opening, indicating that the method of the invention preserves the roasted whole coffee beans from aging better than the conventional methods of the prior art.

The above embodiment is described by way of example only. Many variations are possible without departing from the scope of the invention as defined in the appended claims.

1. A method of treating a roasted beverage ingredient, the method comprising the step of:
a) incubating the ingredient at between −10° C. and 8° C. for 30 to 300 minutes.

2. A method of treating a roasted beverage ingredient according to claim 1 wherein the incubating step a) comprises contacting the ingredient with one or more cooling agent.

3. A method of treating a roasted beverage ingredient according to claim 1 wherein the incubating step a) is performed in a refrigerated vessel.

4. A method of treating a roasted beverage ingredient according to claim 1 wherein the method further comprises, before step a), the step of:
b) reducing the amount of oxygen surrounding the ingredient down to less than 5%.

5. A method of treating a roasted beverage ingredient according to claim 4 wherein step b) comprises a cooled fluid flushing of the ingredient.

6. A method of treating a roasted beverage ingredient according to claim 1 wherein the method further comprises, during or after step a), the step of:
c) packing the ingredient.

7. A method of treating a roasted beverage ingredient according to claim 6 wherein the method comprises after step c) the step of:
d) storing the ingredient at a temperature at between 2° C. and ambient temperature for at least 1 week before first opening.

8. A method of treating a roasted beverage ingredient according to claim 7 wherein step d) lasts between 2 to 52 weeks before first opening of the packaged ingredient.

9. A method of treating a roasted beverage ingredient according to claim 7 or 8 wherein step d) is carried out at a temperature between 8 to 25° C.

10. A method as claimed in claim 1, wherein the roasted beverage ingredient comprises roasted coffee.

11. A packaged beverage ingredient obtained or obtainable by the method as claimed in claim 1 wherein the packaged ingredient is characterised by a 2-butanone to methanethiol concentration ratio of no more than 20:1 in the packaged ingredient on the day of first opening of the packaged ingredient, and a 2-butanone to methanethiol concentration ratio of no more than 110:1 seven days after first opening.

12. A packaged beverage ingredient according to claim 11 wherein the ingredient comprises roasted whole coffee beans.

13. A packaged beverage ingredient according to claim 11 wherein the roasted whole coffee beans comprises Arabica whole coffee beans.

14. A packaged beverage ingredient according to claim 11 wherein the roasted whole coffee beans comprises Robusta whole coffee beans.

15. A packaged beverage ingredient according to claim 14 comprising a blend of Robusta and Arabica whole coffee beans, wherein the Robusta and Arabica whole coffee beans blend comprises an Arabica to Robusta whole coffee beans blend ratio in the range of 50%:50% to 90%:10%.

16. A packaged beverage ingredient according to claim 14 or 15 wherein the packaged ingredient is characterised by a 2-butanone to methanethiol concentration ratio of no more than 10:1 in the packaged ingredient on the day of first opening of the packaged ingredient, and a 2-butanone to methanethiol concentration ratio of no more than 60:1 seven days after first opening.

17. A packaged beverage ingredient according to claim 13 wherein the packaged ingredient is characterised by a 2-butanone to methanethiol concentration ratio of no more than 10:1 in the packaged ingredient on the day of first opening of the packaged ingredient, and a 2-butanone to methanethiol concentration ratio of no more than 105:1 seven days after first opening.

18. A packaged beverage ingredient according to claim 14 wherein the packaged ingredient is characterised by a 2-butanone to methanethiol concentration ratio of no more than 20:1 in the packaged ingredient on the day of first opening of the packaged ingredient, and a 2-butanone to methanethiol concentration ratio of no more than 80:1 seven days after first opening.

19. A packaged beverage ingredient according to claim 11 wherein the ingredient is stored for at least 1 week after packing and before first opening.

20. Packaged roast coffee, wherein the coffee is characterised by a 2-butanone to methanethiol concentration ratio of no more than 20:1 in the packaged ingredient on the day of first opening of the packaged ingredient, and a 2-butanone to methanethiol concentration ratio of no more than 110:1 seven days after first opening.

21. Packaged roast coffee as claimed in claim 20, wherein the coffee is in the form of whole roasted coffee beans.
